(19) United States
(12) Patent Application Publication
(10) Pub. No.: US 2023/0329397 A1
(43) Pub. Date: Oct. 19, 2023

(54) SHOE UPPER MEMBER WITH DESIGN AND MANUFACTURING METHOD THEREOF

(71) Applicant: Art printech co., ltd, Busan (KR)

(72) Inventor: Yukyung YANG, Busan (KR)

(73) Assignee: Art printech co., ltd, Busan (KR)

(21) Appl. No.: 18/125,506

(22) Filed: Mar. 23, 2023

(30) Foreign Application Priority Data
Apr. 14, 2022 (KR) 10-2022-0046400

(51) Int. Cl. A43B 23/02; B29D 35/00

(52) U.S. Cl. CPC A43B 23/0235; A43B 23/0255; B29D 35/00

(57) ABSTRACT

There is provided a shoe upper member. The shoe upper member includes: a coating layer protecting the printing layer on the upper part of the printing layer; a protective film layer located above the coating layer to protect the coating layer; a microprism layer formed on the lower side of the printing layer and formed by a plurality of projections protruding downward; and an adhesive layer formed below the microprism layer and formed so that it can be attached to the fabric. The microprism layer is a patterned shoe shell skin material characterized in that the printing layer is imprinted in a microprism shape and then fixed by UV curing.

### CROSS-REFERENCE TO RELATED APPLICATION

This application claims priority to Korean Patent Application No. 10-2022-0046400 (filed on Apr. 14, 2022), which is hereby incorporated by reference in its entirety.

### BACKGROUND

The present invention relates to a shoe upper member with a design, and more specifically, a shoe upper member with a durable pattern with a brilliant color and a manufacturing method thereof.

A reflective sheet is a reflector that reflects incident light in the direction incident, including a condensing layer and a reflective layer. The reflective sheet is usually formed in the form of a sheet and is processed into a desired shape or pattern on the surface of the body of the adherendent and attached to a selected part of a uniform such as a road sign or a firefighter by a method such as hot pressing or sewing, thereby improving visibility, so that the surrounding environment can be easily displayed even in the dark. Therefore, when reflective sheets are attached to the clothing worn by people working on roads or dangerous places, such as environmental beautification workers, firefighters, police, factory workers, construction site workers, and safety personnel in various parts, it can reliably confirm the wearer's position to the surrounding people, which has a great effect on the protection and safety of the wearer.

However, in the prior art, there have been the following problems.

In the case of the existing shoe upper members used for logos of shoe fabrics, it is composed of several layers, and there is a problem that each layer is separated by use and is not durable.

### SUMMARY

Therefore, embodiments of the invention have been made in view of the above problems, it is an object of the present invention to provide a shoe upper member with design and a manufacturing method that in which a brilliant color can be freely added, and a durable pattern is formed.

In order to achieve the above-described object, the shoe upper member with design of the present invention includes a printing layer in which a pattern and a shape are formed, a coating layer protecting the printing layer on the upper part of the printing layer, a protective film layer located above the coating layer to protect the coating layer, a microprism layer formed on the lower side of the printing layer and formed by protruding a plurality of protrusions downwards, and an adhesive layer formed on the lower side of the microprism layer so that it can be attached to the fabric, wherein the microprism layer is fixed by UV curing after imprinting the printing layer in a microprism shape.

Another embodiment of the present invention, a method for manufacturing a shoe upper member with design, includes a first step of forming a coating layer on one side of the protective film layer, a second step of forming a printing layer on the coating layer, and a third step of imprinting the other side of the printing layer in a microprism shape, a fourth step of UV-curing and fixing the other side of the printing layer in which the microprism shape is formed, and a fifth step of forming an adhesive layer on the other side of the printing layer.

In the present invention, a shoe upper member with design and a manufacturing method that have the following effect.

Imprinted microprism shape formed on the lower part of the printing layer of the sheet, and then fixed through UV curing, and an adhesive of the same material as the printing layer is used to ensure that each layer is not separated by external heat or impact, so it is highly durable.

### BRIEF DESCRIPTION OF THE DRAWINGS

FIG. 1 is a cross-sectional view showing the structure of a preferred embodiment of a shoe upper member with design according to the present invention.

FIG. 2 is a flowchart showing a manufacturing process of a shoe upper member with design of the present invent ion.

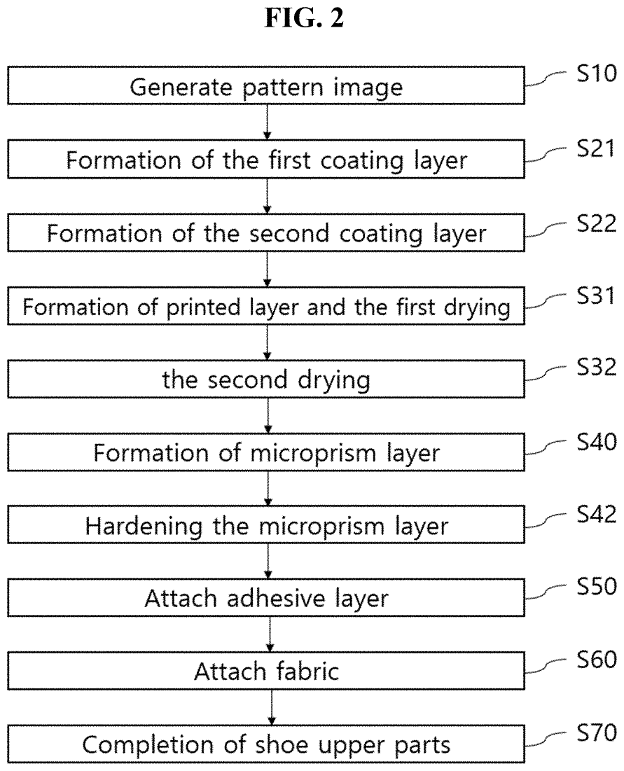

FIG. 3 is a flowchart showing another embodiment of the manufacturing process of a a shoe upper member with design of the present invention.

### DETAILED DESCRIPTION

The contents below, a shoe upper member with design according to the present invention and a preferred embodiment of a manufacturing method thereof will be described in detail with reference to the accompanying drawings.

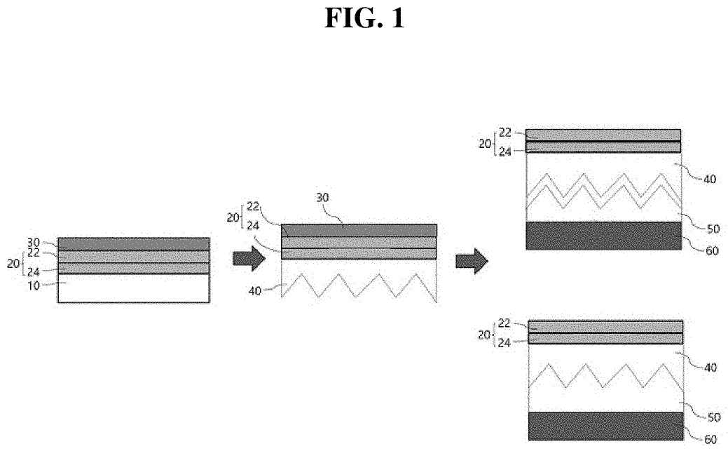

As shown in FIG. 1, a shoe upper member with design of the present invention consisting of a printing layer(10) in which a pattern and a shape are formed, a coating layer(20) protecting the printing layer(10) above the printing layer(10), a protective film layer(30) located above the coating layer(20) to protect the coating layer(20), and a microprism layer(40) formed in the lower part of the printing layer(10) and formed by protruding a plurality of protrusions downwards, It may include an adhesive layer(50) formed below the microprism layer(40) and formed so that it can be attached to the fabric.

First, a printing layer(10) is provided in a shoe upper member with design of the present invention. The printing layer(10) may be formed by printing a pattern image using the pigment on one side of the coating layer(20) to be described below using a polyurethane(PU) pigment.

The pattern image expresses a shape or pattern to be given to shoes such as artificial leather, and can be realized as a pattern image that is a repetitive image.

The pattern image can be formed in various ways, for example, using the pigment spraying method of a digital printer, color expression can be made with rich color, print quality is good, and it can express fine and elaborate images, so high-resolution images can be printed.

In addition, a coating layer(20) is provided on the upper surface of the printing layer(10). The coating layer(20) protects the printing layer(10) and may be formed of polyurethane(PU) resin. This is to allow the pigment composed of polyurethane of the printing layer(10) to interact with the coating layer(20) and be securely fixed.

The coating layer(20) may be composed of one layer, and the coating layer(20) may be formed by dividing it into a first coating layer(22) and a second coating layer(24). This is because when the coating layer(20) is formed from 24 to 36 μm at a time, the coating layer(20) is formed in one process, and there is a high probability that an insufficient part of the coating layer(20) may occur, and when it occurs, it is to compensate for it by dividing the coating layer(20) into two layers and proceeding with another process.

In addition, a protective film layer(30) is provided on the upper surface of the coating layer(20). The protective film layer(30) serves to protect the coating layer(20). The protective film layer(30) may be formed of a film of various materials, and in the present invention may be made of a poly ethylene terephthalate material.

The thickness of the protective film layer(30) may be composed of 100˜120 μm. When the thickness of the protective film layer(30) is less than 100 μm, when printing a pattern image on the printing layer(10), wrinkles may occur in the protective film layer(30) and may be difficult to form the printing layer(10), and when the thickness of the protective film layer(30) exceeds 120 μm, when printing the pattern image on the printing layer(10), the protective film layer(30) is thick and lacks flexibility, so it may be difficult to form the printing layer(10).

The protective film layer(30) may not be applied according to the physical properties of the coating layer(20). That is, when the coating layer(30) becomes a sufficient thickness or when physical properties that can accommodate the function of the protective film layer(30) are secured, the protective film layer(30) is not necessary.

In addition, a microprism layer(40) is provided at the bottom of the printing layer(10). The microprism layer(40) may be formed of polyurethane resin in the same way as the coating layer(20) described above. This is to ensure that the pigment composed of polyurethane resin of the printing layer(10) interacts with the microprism layer(40) and is securely fixed.

In addition, the microprism layer(40) may be imprinted using a tool formed of the microprism(40) on the lower side of the printing layer(10) to form a layer.

In order to fix the microprism layer(40), a microprism(40) may be formed on the lower side of the printing layer(10) and cured by irradiating UV. This is to prevent the microprism layer(40) from collapsing while forming an adhesive layer or the like from below.

The microprism layer(40) is formed of a plurality of projections downward, as shown in FIG. 1. The protrusions protrude downward of the microprism layer(40) so that the reflectivity increases with the reflective components included in the adhesive layer(50) to be described below.

The protrusions can be formed both regularly or irregularly at the same height, and can be of any shape as long as they can protrude downwards. The shape of the protrusion is preferably formed in the shape of a horn, and it is most preferably formed in the shape of a square cone.

Downside of the microprism layer(40), an adhesive layer(50) is formed. The adhesive layer(50) serves to fix the reflective sheet of the present invention to be attached to a fabric such as a shoe or leather. The adhesive layer(50) may be composed of various materials, and the formulation may also be composed of a hot melt adhesive or the like.

The adhesive layer(50) may be to bond the shoe upper member to the shoe upper when the shoe upper member is applied to the shoe upper, and the adhesive layer(50) may be a layer composed of a hot melt adhesive manufactured of a polymer resin. More preferably, the adhesive layer(50) may consist of any one or more selected from ethylene-vinyl acetate system, polyolefin system, styrene block copolymerization system, polyamide system, polyester system, urethane system. In the present invention, it is preferable to be made of a polyurethane (PU) type adhesive.

In addition, the adhesive layer(50) may be composed of a polyester-based hot melt adhesive having a melting temperature of 110˜140° C. The adhesive layer(50) is not limited to having a melting temperature of 110° C. or less, but exceeding 140° C. may cause damage to the coating layer(20), the printing layer(10), and the fabric(60).

In addition, the adhesive layer(50) may have a thickness of 100˜150 μm. If the thickness of the adhesive layer(50) is less than 100 μm, the adhesive strength may decrease due to the thickness of the adhesive layer(50) when attaching the shoe upper member to the shoe upper, and if the thickness exceeds 150 μm, the bonding strength is sufficient, and further increase in thickness is meaningless, and the unit cost of the shoe upper member manufactured may be higher due to the large amount of the adhesive layer(50) used.

Using the adhesive layer(50), the shoe upper member can be easily applied to the shoe upper through the attachment of the adhesive layer(50) to the fabric(60), so that a complicated sewing process is not required. It can be simplified, and a seam line due to the sewing process is not formed on one surface of the shoe upper member, so that the aesthetics of the shoe upper member and the shoe upper can be improved.

The adhesive layer(50) is composed of a transparent material, and a reflective material of a solid such as a high brightness luminescent pigment or aluminum (Al) may be further added to the adhesive layer(50) to increase the reflection efficiency. The reflective material may be mixed in a ratio of 5 to 30 parts by weight to 90 parts by weight of the adhesive resin. This is because when the reflective material is mixed with less than 5 parts by weight, the reflection efficiency is lowered, and when mixed with more than 30 parts by weight, the adhesion performance decreases.

Next, a method of manufacturing a shoe upper member with design, which is the first embodiment of the present invention, will be described.

First, the manufacturing method of the shoe upper member with design according to the present invention is a first step(S10) of generating a pattern image by preparing an image expressing a predetermined shape and pattern.

Specifically, the preset shape and pattern represented in the image represent a shape or pattern to be given to the shoe, and the preset shape and pattern are expressed to generate a pattern image.

Generating the pattern image is to continuously repeat the image to have a size equal to or smaller than the size of the release paper(100), but to form a single layout of the continuous images. In generating the pattern image, at least one of the brightness value, the contrast value, the saturation value, and the color generation value having the pattern image according to the shoe upper member is corrected according to the input of the user, And a pattern image according to the corrected value may be generated.

On the other hand, in generating a pattern image, a pattern image can be generated by continuously repeating a plurality of images by leaving a predetermined length tolerance between the images. The length of the tolerance is preferably less than the length of the horizontal and vertical length of the image.

Here, if the image is arranged in one layer to form a pattern image, it may be easy to make a plurality of shoe upper members using one image.

Therefore, the manufacturing method of the patterned shoe upper member according to an embodiment of the present invention has the advantage of increasing the manufacturing efficiency and yield in manufacturing the patterned shoe upper member.

Next, a second step (S20) is performed in which polyurethane resin is applied to one side of the protective film layer(30) and aged to form the coating layer(20).

Here, the thickness of the protective film layer(30) is 100˜120 μm and may be made of a poly ethylene terephthalate material.

When the thickness of the protective film layer(30) is less than 100 μm, when printing a pattern image on the printing layer(10), wrinkles may occur in the protective film layer(30) and may be difficult to form the printing layer(10), When the thickness of the protective film layer(30) exceeds 120 μm, when printing a pattern image on the printing layer(10), the protective film layer(30) is thick and lacks flexibility, so deformation easily occurs. So may be difficult to form the pinting layer(10).

In addition, when the protective film layer(30) is coated with polyurethane resin, polyurethane particles, which are components of pigments used to form the printing layer(10), and polyurethane particles of the coating layer(20) interact to improve the adhesion of the coating layer(20) and the printing layer(10). Therefore, in the sixth step(S60) to be described below, when the adhesive layer(50), the printing layer(10), and the coating layer(20) are stacked in order on one side of the fabric(60), the coating layer(20) is not peeled off from the printing layer(10) and the printing layer(10) is protected to improve the durability of the shoe upper member.

In addition, in the second step (S20), a polyurethane resin is applied to one side of the protective film layer(30) and aged at 65 to 75° C. for 20 to 28 hours to form a first coating layer having a thickness of 12 to 18 μm. 2-1 step(S21) of forming(210), polyurethane resin is applied to one surface of the first coating layer(210), and aged at 65 to 75° C. for 20 to 28 hours to obtain a thickness of 12 to 18 μm. It can be divided into a 2-2 step(S22) of forming the second coating layer(220).

Here, if the ripening temperature is less than 65° C., the productivity may decrease due to a long time of aging, and if the aging temperature exceeds 75° C., the protective film layer(30) or the polyurethane resin may be deformed. In addition, if the aging time is less than 20 hours, the ripening may not be sufficient, and if it exceeds 28 hours, further aging is meaningless, and the ripening time may take a long time and the productivity may decrease.

In addition, when the coating layer(20) is formed at 24˜36 μm at one time, an incomplete coating may be formed so that the coating layer(20) may not effectively protect the printed layer(10). So that the coating layer(22) and the second coating layer(24) are divided and applied. In addition, in the 2-2 step(S22), polyurethane resin is applied to one surface of the first coating layer(22) and coated to further coat one surface of the first coating layer(22) at the same time.

If the thickness of the coating layer(20) composed of the first coating layer(22) and the second coating layer(24) is less than 24 μm, the strength of the coating layer(20) is weak and does not effectively protect the printing layer(10), and the durability of the shoe upper member may decrease, and when the thickness of the coating layer(20) composed of the first coating layer(22) and the second coating layer(24) exceeds 36 μm, the flexibility of the coating layer(20) decreases, and when the shoe upper member is applied to one side of the curved shoe, the shoe upper member There may be difficulties such as deformation and wrinkles.

Next, a third step(S30) of printing the pattern image on one side of the coating layer(20) to form and dry the printing layer(10) is performed.

Here, the pattern image is smaller in size than the protective film layer(30) prepared in the first step(S10), and repeats an image expressing a predetermined shape and pattern.

In this case, the method of printing a pattern image using a pigment on one surface of the coating layer(20) may be a pigment spraying method using a digital printer. The pigment spraying method using a digital printer has the advantage of excellent color expression with rich color, fine print quality, precise expression, and high-resolution image printing. Therefore, when using the pigment spraying method using a digital printer in the third step(S30) of the shoe upper member formed in the pattern of the present invention, the pigment used may include a polyurethane component.

In the third step(S30), the pigment may be printed on one side of the coating layer(200) at a printing layer(10) formation rate of 10˜20 m²/h.

When the printing layer(10) formation speed is less than 10 m²/h, the printing layer(10) formation speed on one side of the coating layer(20) may be too slow and productivity may decrease, and if the printing layer(10) formation speed exceeds 20 m²/h, the speed may be fast, resulting in an insufficient printing part on one side of the coating layer(20) or a decrease in print quality.

In addition, in the third step(S30), the step of drying the formed printing layer is a 3-1 step(S31) of directly heating and drying the printing layer(10) for 55˜65 seconds using a heating plate of 55˜65° C., and a 3-2 step(S32) of heating and drying by applying heat and hot air of 70˜80° C. to the printing layer(10) for 55˜65 seconds.

If the heating temperature in the 3-1 step (S31) is less than 55° C., the heating time may be prolonged and the productivity may decrease, and if the 3-1 step(S31) exceeds 65° C., the pigment is initially rapidly dried and the printing layer(10) may be divided. If the heating time exceeds 65 seconds in the third 3-1 step(S31), the heating time may be long and productivity may decrease.

If the heating temperature is less than 70° C. in the 3-2 step(S32), the heating time may be prolonged and productivity may decrease, and if the heating temperature exceeds 80° C. in the 3-2 step(S32), damage may occur to the printing layer(10) and the coating layer(20), and if the heating time is less than 55 seconds in the 3-2 step(S32), the heating time is short and the printing layer(10) may not dry sufficiently, If the heating time exceeds 65 seconds in the third and second step(S32), the heating time may be prolonged and productivity may decrease.

Then, a fourth step(S40) of forming a microprism layer(40) on one surface of the printing layer(10) proceeds.

The microprism layer(40) may be imprinted using a roller grooved on the bottom surface of the printing layer(10) or a plate formed in a microprism shape to form a microprism layer.

At this time, the microprism layer(40) may be stably fixed so that the shape of the microprism layer(40) is stably fixed, and then cured using UV rays to ensure that the microprism shape is safely maintained(S42).

In addition, the microprism layer(40) is formed on one side of the printing layer(10). The microprism layer(40) may be manufactured in a state in which a protrusion is formed on one surface and then attached to the surface of the printing layer.

Next, a fifth step (S50) is performed to form an adhesive layer(50) composed of an adhesive(52) and a second protective film layer on one side of the printing layer(10).

The second protective film may play a role in preventing the adhesive(52) from being contaminated with dust or foreign substances. The second protective film may be formed on one surface of the adhesive(52) and bonded to the adhesive(52) in a non-stick manner to be removable without leaving foreign matter on the adhesive(52).

The adhesive(52) may be a layer consisting of a hot melt adhesive having adhesive properties at the time of melting and not being adhesive at room temperature. The hot melt adhesive may be to bond the shoe upper member to the shoe upper when the shoe upper member is applied to the shoe upper, and the hot melt adhesive may be manufactured of a polymer resin. More preferably, the hot melt adhesive may consist of any one or more selected from ethylene-vinyl acetate system, polyolefin system, styrene block copolymerization system, polyamide system, polyester system, urethane system.

In addition, the hot melt adhesive may be composed of a polyester-based hot melt adhesive having a melting temperature of 110˜140° C. The hot melt adhesive is not limited to having a melting temperature of 110° C. or less, but if it exceeds 140° C., it may cause damage to the coating layer(20), the printing layer(10), and the fabric(60).

In addition, the hot melt adhesive may have a thickness of 100˜150 μm. If the thickness of the adhesive(50) is less than 100 μm, the adhesive strength may decrease due to the thin thickness of the adhesive layer(50) when the shoe upper member is attached to the shoe upper, and if the thickness exceeds 150 μm, the bonding strength is sufficient, and further increase in thickness is meaningless, and the unit cost of the shoe upper member manufactured due to the large amount of the hot melt adhesive used may be high.

Next, a sixth step(S60) of separating the second protective film layer and attaching the adhesive(52) to the fabric(60) to obtain a semi-finished product is performed.

In addition, the sixth step(S60) may include attaching the adhesive(52) to one surface of the fabric(60) and aging at 65˜75° C. for 20˜28 hours so that the printing layer(10) is transferred to the fabric(60).

At this time, if the ripening temperature is less than 65° C., the aging time may be longer and the productivity may decrease, and if the aging temperature exceeds 75° C., damage may occur to the fabric (60), and if the aging time is less than 20 hours, the aging may not be sufficient due to the short time. In addition, if the aging time exceeds 28 hours, the aging is completely completed, and it may be difficult to expect further aging effects.

In addition, the sixth step(S60) may include applying heat of 110˜140° C. so that the adhesive(52) is completely attached to one side of the fabric(60).

When the temperature is less than 110° C., the adhesive(52) may not adhere to the fabric(60), and when the temperature exceeds 140° C., the coating layer(20), the printing layer(10), and the fabric(60) may cause damage.

Next, the seventh step (S70) of cutting the semi-finished product to complete the shoe upper member is performed.

The semi-finished product is cut using a cutting mold formed with a plurality of holes corresponding to the shape of the plurality of images formed on the printing layer(10) to complete the shoe upper member.

The seventh step(S70) includes preparing a cutting frame in which a plurality of holes are formed corresponding to the shape and size of a plurality of images arranged continuously repeatedly by placing a tolerance of a predetermined length prepared in the first step(S10), and settling the cutting frame to expose a plurality of images continuously repeated on the top of the semi-finished product, and pressing the cutting frame in the direction of the semi-finished product to separate the semi-finished product correspondingly with the plurality of images.

Next, a method of manufacturing a shoe upper member with design, which is a second embodiment of the present invention, will be described.

First, the manufacturing method of the shoe shell skin material formed by the pattern according to the present invention is a first step(S10) of generating a pattern image by preparing an image expressing a predetermined shape and pattern.

Specifically, the preset shape and pattern represented in the image represent a shape or pattern to be given to the shoe, and the preset shape and pattern are expressed to generate a pattern image.

Generating the pattern image is to continuously repeat the image to have a size equal to or smaller than the size of the release paper(100), but to form a single layout of the continuous images. In generating the pattern image, at least one of the brightness value, the contrast value, the saturation value, and the color generation value having the pattern image according to the shoe upper member is corrected according to the input of the user, And a pattern image according to the corrected value may be generated.

On the other hand, in generating a pattern image, a pattern image can be generated by continuously repeating a plurality of images by leaving a predetermined length tolerance between the images. The length of the tolerance is preferably less than the length of the horizontal and vertical length of the image.

Here, if the image is arranged in one layer to form a pattern image, it may be easy to make a plurality of shoe upper members using one image.

Therefore, the manufacturing method of the patterned shoe upper member according to an embodiment of the present invention has the advantage of increasing the manufacturing efficiency and yield in manufacturing the patterned shoe upper member.

Next, a second step(S20) is performed in which polyurethane resin is applied to one side of the protective film layer(30) and aged to form the coating layer(20).

Here, the thickness of the protective film layer(30) is 100˜120 μm and may be made of a poly ethylene terephthalate material.

When the thickness of the protective film layer(30) is less than 100 μm, when printing a pattern image on the printing layer(10), wrinkles may occur in the protective film layer(30) and may be difficult to form the printing layer(10), When the thickness of the protective film layer(30) exceeds 120 μm, when printing a pattern image on the printing layer(10), the protective film layer(30) is thick and lacks flexibility, so deformation easily occurs. So may be difficult to form the pinting layer(10).

In addition, when the protective film layer(30) is coated with polyurethane resin, polyurethane particles, which are components of pigments used to form the printing layer(10), and polyurethane particles of the coating layer(20) interact to improve the adhesion of the coating layer(20) and the printing layer(10). Therefore, in the sixth step(S60) to be described below, when the adhesive layer(50), the printing layer(10), and the coating layer(20) are stacked in order on one side of the fabric(60), the coating layer(20) is not peeled off from the printing layer(10) and the printing layer(10) is protected to improve the durability of the shoe upper member.

In addition, in the second step (S20), a polyurethane resin is applied to one side of the protective film layer(30) and aged at 65 to 75° C. for 20 to 28 hours to form a first coating layer having a thickness of 12 to 18 μm. 2-1 step(S21) of forming(210), polyurethane resin is applied to one surface of the first coating layer(210), and aged at 65 to 75° C. for 20 to 28 hours to obtain a thickness of 12 to 18 μm. It can be divided into a 2-2 step(S22) of forming the second coating layer(220).

Here, if the ripening temperature is less than 65° C., the productivity may decrease due to a long time of aging, and if the aging temperature exceeds 75° C., the protective film layer(30) or the polyurethane resin may be deformed. In addition, if the aging time is less than 20 hours, the ripening may not be sufficient, and if it exceeds 28 hours, further aging is meaningless, and the ripening time may take a long time and the productivity may decrease.

In addition, when the coating layer(20) is formed at 24˜36 μm at one time, an incomplete coating may be formed so that the coating layer(20) may not effectively protect the printed layer(10). So that the coating layer(22) and the second coating layer(24) are divided and applied. In addition, in the 2-2 step(S22), polyurethane resin is applied to one surface of the first coating layer(22) and coated to further coat one surface of the first coating layer(24) at the same time.

If the thickness of the coating layer(20) composed of the first coating layer(22) and the second coating layer(24) is less than 24 μm, the strength of the coating layer(20) is weak and does not effectively protect the printing layer(10), and the durability of the shoe upper member may decrease, and when the thickness of the coating layer(20) composed of the first coating layer(22) and the second coating layer(24) exceeds 36 μm, the flexibility of the coating layer(20) decreases, and when the shoe upper member is applied to one side of the curved shoe, the shoe upper member There may be difficulties such as deformation and wrinkles.

Next, a third step(S30) of printing the pattern image on one side of the coating layer(20) to form and dry the printing layer(10) is performed.

Here, the pattern image is smaller in size than the protective film layer(30) prepared in the first step(S10), and repeats an image expressing a predetermined shape and pattern.

In this case, the method of printing a pattern image using a pigment on one surface of the coating layer(20) may be a pigment spraying method using a digital printer. The pigment spraying method using a digital printer has the advantage of excellent color expression with rich color, fine print quality, precise expression, and high-resolution image printing.

Therefore, when using the pigment spraying method using a digital printer in the third step (S30) of the shoe upper member formed in the pattern of the present invention, the pigment used may include a polyurethane component.

In the third step(S30), the pigment may be printed on one side of the coating layer 200 at a printing layer(10) formation rate of 10˜20 m²/h.

When the printing layer(10) formation speed is less than 10 m²/h, the printing layer(10) formation speed on one side of the coating layer(20) may be too slow and productivity may decrease, and if the printing layer(10) formation speed exceeds 20 m²/h, the speed may be fast, resulting in an insufficient printing part on one side of the coating layer(20) or a decrease in print quality.

In addition, in the third step(S30), the step of drying the formed printing layer is a 3-1 step (S31) of directly heating and drying the printing layer(10) for 55˜65 seconds using a heating plate of 55˜65° C., and a 3-2 step (S32) of heating and drying by applying heat and hot air of 70˜80° C. to the printing layer(10) for 55˜65 seconds.

If the heating temperature in the 3-1 step (S31) is less than 55° C., the heating time may be prolonged and the productivity may decrease, and if the 3-1 step (S31) exceeds 65° C., the pigment is initially rapidly dried and the printing layer(10) may be divided. If the heating time exceeds 65 seconds in the 3-1 step(S31), the heating time may be long and productivity may decrease.

If the heating temperature is less than 70° C. in the 3-2 step (S32), the heating time may be prolonged and productivity may decrease, and if the heating temperature exceeds 80° C. in the 3-2 step (S32), damage may occur to the printing layer(10) and the coating layer(20), and if the heating time is less than 55 seconds in the 3-2 step (S32), the heating time is short and the printing layer(10) may not dry sufficiently. If the heating time exceeds 65 seconds in the 3-2 step (S32), the heating time may be prolonged and productivity may decrease.

Then, a fourth step (S40) of forming a microprism layer(40) on one surface of the printing layer(10) proceeds.

The microprism layer(40) may be imprinted using a roller grooved on the bottom surface of the printing layer(10) or a plate formed in a microprism shape to form a microprism layer.

At this time, the microprism layer(40) may be stably fixed so that the shape of the microprism layer(40) is stably fixed, and then cured using UV rays to ensure that the microprism shape is safely maintained (S42).

In addition, the microprism layer(40) is formed on one side of the printing layer(10). The microprism layer(40) may be manufactured in a state in which a protrusion is formed on one surface and then attached to the surface of the printing layer.

Next, a fifth step (S50) is performed to form an adhesive layer(50) composed of an adhesive(52) and a second protective film layer on one side of the printing layer(10).

The second protective film layer may play a role in preventing the adhesive(52) from being contaminated with dust or foreign substances. The second protective film layer may be formed on one side of the adhesive(52) and bonded to the adhesive(52) in a non-stick manner and removable without leaving foreign matter on the adhesive(52).

The adhesive(52) is composed of a transparent material, and may be a layer composed of a hot melt adhesive having adhesive properties during melting and not being adhesive at room temperature. The hot melt adhesive may be to bond the shoe upper member to the shoe upper when the shoe upper member is applied to the shoe upper, and the hot melt adhesive may be manufactured of a polymer resin. More preferably, the hot melt adhesive may consist of any one or more selected from ethylene-vinyl acetate system, polyolefin system, styrene block copolymerization system, polyamide system, polyester system, urethane system.

In addition, the hot melt adhesive may be composed of a polyester-based hot melt adhesive having a melting temperature of 110˜140° C. The hot melt adhesive is not limited to having a melting temperature of 110° C. or less, but if it exceeds 140° C., it may cause damage to the coating layer(20), the printing layer(10), and the fabric(60).

In addition, the hot melt adhesive may have a thickness of 100˜150 μm. If the thickness of the adhesive(50) is less than 100 μm, the adhesive strength may decrease due to the thin thickness of the adhesive layer(50) when the shoe upper member is attached to the shoe upper, and if the thickness exceeds 150 μm, the bonding strength is sufficient, and further increase in thickness is meaningless, and the unit cost of the shoe upper member manufactured due to the large amount of the hot melt adhesive used may be high.

Next, a sixth step (S60) of separating the second protective film layer and attaching the adhesive(52) to the fabric(60) to obtain a semi-finished product is performed.

Specifically, the second protective film layer is separated from the adhesive(52). By separating the second protective film layer, the adhesive(52) that is cleanly protected from dust or foreign substances is attached to the fabric(60).

In addition, the sixth step(S60) may include attaching the adhesive(52) to one surface of the fabric 60 and aging at 65˜75° C. for 20˜28 hours so that the printing layer(10) is transferred to the fabric(60).

At this time, if the ripening temperature is less than 65° C., the aging time may be longer and the productivity may decrease, and if the aging temperature exceeds 75° C., damage may occur to the fabric(60), and if the aging time is less than 20 hours, the aging may not be sufficient due to the short time. In addition, if the aging time exceeds 28 hours, the aging is completely completed, and it may be difficult to expect further aging effects.

In addition, the sixth step(S60) may include applying heat of 110˜140° C. so that the adhesive(52) is completely attached to one side of the fabric(60).

When the temperature is less than 110° C., the adhesive(52) may not adhere to the fabric(60), and when the temperature exceeds 140° C., the coating layer(20), the printing layer(10), and the fabric(60) may cause damage.

Next, the seventh step (S70) of cutting the semi-finished product to complete the shoe upper member is performed.

The semi-finished product is cut using a cutting mold formed with a plurality of holes corresponding to the shape of the plurality of images formed on the printing layer(10) to complete the shoe upper member.

The seventh step (S70) includes preparing a cutting frame in which a plurality of holes are formed corresponding to the shape and size of a plurality of images arranged continuously repeatedly by placing a tolerance of a predetermined length prepared in the first step(S10), and settling the cutting frame to expose a plurality of images continuously repeated on the top of the semi-finished product, and pressing the cutting frame in the direction of the semi-finished product to separate the semi-finished product correspondingly with the plurality of images.

Next, a method for manufacturing a shoe upper member with design, which is a third embodiment of the present invention, will be described.

First, the manufacturing method of the shoe shell skin material formed by the pattern according to the present invention is a first step (S10) of generating a pattern image by preparing an image expressing a predetermined shape and pattern.

Specifically, the preset shape and pattern represented in the image represent a shape or pattern to be given to the shoe, and the preset shape and pattern are expressed to generate a pattern image.

Generating the pattern image is to continuously repeat the image to have a size equal to or smaller than the size of the release paper 100, but to form a single layout of the continuous images. In generating the pattern image, at least one of the brightness value, the contrast value, the saturation value, and the color generation value having the pattern image according to the shoe upper member is corrected according to the input of the user, And a pattern image according to the corrected value may be generated.

On the other hand, in generating a pattern image, a pattern image can be generated by continuously repeating a plurality of images by leaving a predetermined length tolerance between the images. The length of the tolerance is preferably less than the length of the horizontal and vertical length of the image.

Here, if the image is arranged in one layer to form a pattern image, it may be easy to make a plurality of shoe upper members using one image.

Therefore, the manufacturing method of the shoe upper member with design according to an embodiment of the present invention has the advantage of increasing the manufacturing efficiency and yield in manufacturing the patterned shoe upper member.

Next, a second step (S20) is performed in which polyurethane resin is applied to one side of the protective film layer(30) and aged to form the coating layer(20).

Here, the thickness of the protective film layer(30) is 100˜120 μm and may be made of a poly ethylene terephthalate material.

When the thickness of the protective film layer(30) is less than 100 μm, when printing a pattern image on the printing layer(10), wrinkles may occur in the protective film layer(30) and may be difficult to form the printing layer(10). When the thickness of the protective film layer 30 exceeds 120 μm, when a pattern image is printed on the printed layer(10), the protective film layer 30 is thick and lacks flexibility, so deformation easily occurs. So it may be difficult to form the printed layer(10).

In addition, when the protective film layer(30) is coated with polyurethane resin, polyurethane particles, which are components of pigments used to form the printing layer(10), and polyurethane particles of the coating layer(20) interact to improve the adhesion of the coating layer(20) and the printing layer(10). Therefore, in the sixth step(S60) to be described below, when the adhesive layer(50), the printing layer(10), and the coating layer(20) are stacked in order on one side of the fabric(60), the coating layer(20) is not peeled off from the printing layer(10) and the printing layer(10) is protected to improve the durability of the shoe upper member.

In addition, in the second step (S20), a polyurethane resin is applied to one side of the protective film layer(30) and aged at 65 to 75° C. for 20 to 28 hours to form a first coating layer having a thickness of 12 to 18 μm. 2-1 step(S21) of forming(210), polyurethane resin is applied to one surface of the first coating layer(210), and aged at 65 to 75° C. for 20 to 28 hours to obtain a thickness of 12 to 18 μm. It can be divided into a 2-2 step(S22) of forming the second coating layer(220).

Here, if the ripening temperature is less than 65° C., the productivity may decrease due to a long time of aging, and if the aging temperature exceeds 75° C., the protective film layer(30) or the polyurethane resin may be deformed. In addition, if the aging time is less than 20 hours, the ripening may not be sufficient, and if it exceeds 28 hours, further aging is meaningless, and the ripening time may take a long time and the productivity may decrease.

In addition, when the coating layer(20) is formed at 24˜36 μm at one time, an incomplete coating may be formed so that the coating layer(20) may not effectively protect the printed layer(10). So that the coating layer(22) and the second coating layer(24) are divided and applied. In addition, in the 2-2 step(S22), polyurethane resin is applied to one surface of the first coating layer(22) and coated to further coat one surface of the first coating layer(22) at the same time.

If the thickness of the coating layer(20) composed of the first coating layer(22) and the second coating layer(24) is less than 24 μm, the strength of the coating layer(20) is weak and does not effectively protect the printing layer(10), and the durability of the shoe upper member may decrease, and when the thickness of the coating layer(20) composed of the first coating layer(22) and the second coating layer(24) exceeds 36 μm, the flexibility of the coating layer(20) decreases, and when the shoe upper member is applied to one side of the curved shoe, the shoe upper member There may be difficulties such as deformation and wrinkles.

Next, a third step (S30) of printing the pattern image on one side of the coating layer(20) to form and dry the printing layer(10) is performed.

Here, the pattern image is smaller in size than the protective film layer(30) prepared in the first step(S10), and repeats an image expressing a predetermined shape and pattern.

In this case, the method of printing a pattern image using a pigment on one surface of the coating layer(20) may be a pigment spraying method using a digital printer. The pigment spraying method using a digital printer has the advantage of excellent color expression with rich color, fine print quality, precise expression, and high-resolution image printing. Therefore, when using the pigment spraying method using a digital printer in the third step (S30) of the shoe upper member formed in the pattern of the present invention, the pigment used may include a polyurethane component.

In the third step(S30), the pigment may be printed on one side of the coating layer 200 at a printing layer(10) formation rate of 10˜20 m²/h.

When the printing layer(10) formation speed is less than 10 m²/h, the printing layer(10) formation speed on one side of the coating layer(20) may be too slow and productivity may decrease, and if the printing layer(10) formation speed exceeds 20 m²/h, the speed may be fast, resulting in an insufficient printing part on one side of the coating layer(20) or a decrease in print quality.

In addition, in the third step (S30), the step of drying the formed printing layer is a 3-1 step (S31) of directly heating and drying the printing layer(10) for 55˜65 seconds using a heating plate of 55˜65° C., and a 3-2 step (S32) of heating and drying by applying heat and hot air of 70˜80° C. to the printing layer(10) for 55˜65 seconds.

If the heating temperature in the 3-1 step (S31) is less than 55° C., the heating time may be prolonged and the productivity may decrease, and if the 3-1 step (S31) exceeds 65° C., the pigment is initially rapidly dried and the printing layer(10) may be divided. If the heating time exceeds 65 seconds in the 3-1 step (S31), the heating time may be long and productivity may decrease.

If the heating temperature is less than 70° C. in the 3-2 step (S32), the heating time may be prolonged and productivity may decrease, and if the heating temperature exceeds 80° C. in the 3-2 step (S32), damage may occur to the printing layer(10) and the coating layer(20), and if the heating time is less than 55 seconds in the 3-2 step (S32), the heating time is short and the printing layer(10) may not dry sufficiently, If the heating time exceeds 65 seconds in the 3-2 step (S32), the heating time may be prolonged and productivity may decrease.

Then, a fourth step (S40) of forming a microprism layer(40) on one surface of the printing layer(10) proceeds.

The microprism layer(40) may be imprinted using a roller grooved on the bottom surface of the printing layer(10) or a plate formed in a microprism shape to form a microprism layer.

At this time, the microprism layer(40) may be stably fixed so that the shape of the microprism layer(40) is stably fixed, and then cured using UV rays to ensure that the microprism shape is safely maintained.

In addition, the microprism layer(40) is formed on one side of the printing layer(10). The microprism layer(40) may be manufactured in a state in which a protrusion is formed on one surface and then attached to the surface of the printing layer.

Next, a fifth step (S50) is performed to form an adhesive layer(50) composed of an adhesive(52) and a solid garden end on one surface of the printing layer(10).

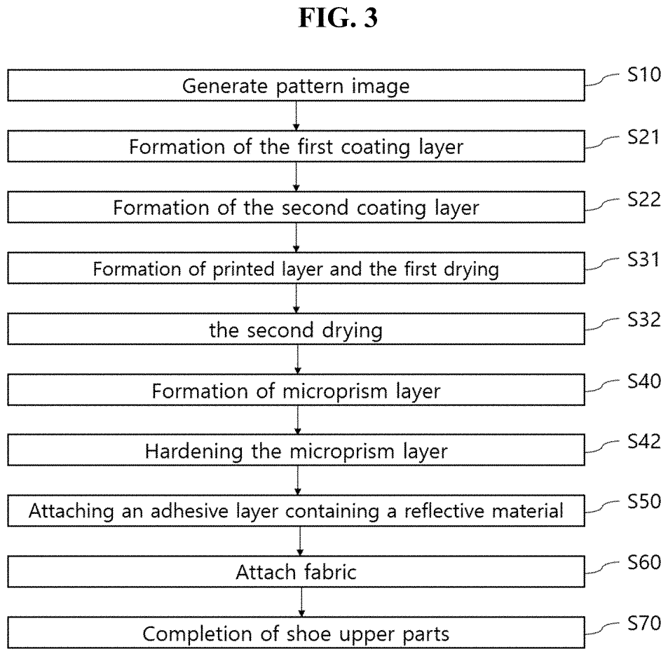

The adhesive layer(50) may include an adhesive(52) and a solid garden end, and may be laminated in the order of the adhesive(52) and the solid garden end on one side of the printing layer(10) as shown in FIG. 3.

The adhesive may be applied to any product that can be used as an adhesive, for example, TPU may be applied. The adhesive is preferably composed of TPU of a transparent material.

In addition, the high garden end is composed of artificial leather and can be fixed to the fabric through sewing.

A sixth step (S60) of obtaining a semi-finished product in which the solid end, the adhesive(52), the microprism layer(40), the printing layer(10), and the coating layer(20) are stacked on one side of the fabric(60) are performed in turn.

Next, the seventh step (S70) of cutting the semi-finished product to complete the shoe upper member is performed.

The semi-finished product is cut using a cutting mold formed with a plurality of holes corresponding to the shape of the plurality of images formed on the printing layer(10) to complete the shoe upper member.

The seventh step (S70) includes preparing a cutting frame in which a plurality of holes are formed corresponding to the shape and size of a plurality of images arranged continuously repeatedly by placing a tolerance of a predetermined length prepared in the first step(S10), and settling the cutting frame to expose a plurality of images continuously repeated on the top of the semi-finished product, and pressing the cutting frame in the direction of the semi-finished product to separate the semi-finished product correspondingly with the plurality of images.

Next, a method of manufacturing a shoe upper member with design of the fourth embodiment of the present invention will be described.

First, the manufacturing method of the shoe shell skin material formed by the pattern according to the present invention is a first step (S10) of generating a pattern image by preparing an image expressing a predetermined shape and pattern.

Specifically, the preset shape and pattern represented in the image represent a shape or pattern to be given to the shoe, and the preset shape and pattern are expressed to generate a pattern image.

Generating the pattern image is to continuously repeat the image to have a size equal to or smaller than the size of the release paper 100, but to form a single layout of the continuous images. In generating the pattern image, at least one of the brightness value, the contrast value, the saturation value, and the color generation value having the pattern image according to the shoe upper member is corrected according to the input of the user, And a pattern image according to the corrected value may be generated.

On the other hand, in generating a pattern image, a pattern image can be generated by continuously repeating a plurality of images by leaving a predetermined length tolerance between the images. The length of the tolerance is preferably less than the length of the horizontal and vertical length of the image.

Here, if the image is arranged in one layer to form a pattern image, it may be easy to make a plurality of shoe upper members using one image.

Therefore, the manufacturing method of the patterned shoe upper member according to an embodiment of the present invention has the advantage of increasing the manufacturing efficiency and yield in manufacturing the patterned shoe upper member.

Next, a second step (S20) is performed in which polyurethane resin is applied to one side of the protective film layer(30) and aged to form the coating layer(20).

Here, the thickness of the protective film layer(30) is 100˜120 μm and may be made of a poly ethylene terephthalate material.

When the thickness of the protective film layer(30) is less than 100 μm, when printing a pattern image on the printing layer(10), wrinkles may occur in the protective film layer(30) and may be difficult to form the printing layer(10), When the thickness of the protective film layer(30) exceeds 120 μm, when printing a pattern image on the printing layer(10), the protective film layer(30) is thick and lacks flexibility, so deformation easily occurs. So may be difficult to form the pinting layer(10).

In addition, when the protective film layer(30) is coated with polyurethane resin, polyurethane particles, which are components of pigments used to form the printing layer(10), and polyurethane particles of the coating layer(20) interact to improve the adhesion of the coating layer(20) and the printing layer(10). Therefore, in the sixth step(S60) to be described below, when the adhesive layer(50), the printing layer(10), and the coating layer(20) are stacked in order on one side of the fabric(60), the coating layer(20) is not peeled off from the printing layer(10) and the printing layer(10) is protected to improve the durability of the shoe upper member.

In addition, in the second step (S20), a polyurethane resin is applied to one side of the protective film layer(30) and aged at 65 to 75° C. for 20 to 28 hours to form a first coating layer having a thickness of 12 to 18 μm. 2-1 step(S21) of forming(210), polyurethane resin is applied to one surface of the first coating layer(210), and aged at 65 to 75° C. for 20 to 28 hours to obtain a thickness of 12 to 18 μm. It can be divided into a 2-2 step(S22) of forming the second coating layer(220).

Here, if the ripening temperature is less than 65° C., the productivity may decrease due to a long time of aging, and if the aging temperature exceeds 75° C., the protective film layer(30) or the polyurethane resin may be deformed. In addition, if the aging time is less than 20 hours, the ripening may not be sufficient, and if it exceeds 28 hours, further aging is meaningless, and the ripening time may take a long time and the productivity may decrease.

In addition, when the coating layer(20) is formed at 24˜36 μm at one time, a part with insufficient coating may be formed, and the coating layer(20) may not effectively protect the printing layer(10). In addition, in the 2-2 step(S22), polyurethane resin is applied to one surface of the first coating layer(22) and coated to further coat one surface of the first coating layer(22) at the same time.

If the thickness of the coating layer(20) composed of the first coating layer(22) and the second coating layer(24) is less than 24 μm, the strength of the coating layer(20) is weak and does not effectively protect the printing layer(10), and the durability of the shoe upper member may decrease, and when the thickness of the coating layer(20) composed of the first coating layer(22) and the second coating layer(24) exceeds 36 μm, the flexibility of the coating layer(20) decreases, and when the shoe upper member is applied to one side of the curved shoe, the shoe upper member There may be difficulties such as deformation and wrinkles.

Next, a third step (S30) of printing the pattern image on one side of the coating layer(20) to form and dry the printing layer(10) is performed.

Here, the pattern image is smaller in size than the protective film layer(30) prepared in the first step(S10), and repeats an image expressing a predetermined shape and pattern.

In this case, the method of printing a pattern image using a pigment on one surface of the coating layer(20) may be a pigment spraying method using a digital printer. The pigment spraying method using a digital printer has the advantage of excellent color expression with rich color, fine print quality, precise expression, and high-resolution image printing. Therefore, when using the pigment spraying method using a digital printer in the third step (S30) of the shoe upper member formed in the pattern of the present invention, the pigment used may include a polyurethane component.

In the third step(S30), the pigment may be printed on one side of the coating layer(200) at a printing layer(10) formation rate of 10˜20 m²/h.

When the printing layer(10) formation speed is less than 10 m²/h, the printing layer(10) formation speed on one side of the coating layer(20) may be too slow and productivity may decrease, and if the printing layer(10) formation speed exceeds 20 m²/h, the speed may be fast, resulting in an insufficient printing part on one side of the coating layer(20) or a decrease in print quality.

In addition, in the third step (S30), the step of drying the formed printing layer is a 3-1 step (S31) of directly heating and drying the printing layer(10) for 55˜65 seconds using a heating plate of 55˜65° C., and a 3-2 step (S32) of heating and drying by applying heat and hot air of 70˜80° C. to the printing layer(10) for 55˜65 seconds.

If the heating temperature in the 3-1 step (S31) is less than 55° C., the heating time may be prolonged and the productivity may decrease, and if the 3-1 step (S31) exceeds 65° C., the pigment is initially rapidly dried and the printing layer(10) may be divided. If the heating time exceeds 65 seconds in the 3-1 step (S31), the heating time may be long and productivity may decrease.

If the heating temperature is less than 70° C. in the 3-2 step (S32), the heating time may be prolonged and productivity may decrease, and if the heating temperature exceeds 80° C. in the 3-2 step (S32), damage may occur to the printing layer(10) and the coating layer(20), and if the heating time is less than 55 seconds in the 3-2 step (S32), the heating time is short and the printing layer(10) may not dry sufficiently, If the heating time exceeds 65 seconds in the 3-2 step (S32), the heating time may be prolonged and productivity may decrease.

Then, a fourth step (S40) of forming a microprism layer(40) on one surface of the printing layer(10) proceeds.

The microprism layer(40) may be imprinted using a roller grooved on the bottom surface of the printing layer(10) or a plate formed in a microprism shape to form a microprism layer.

At this time, the microprism layer(40) may be stably fixed so that the shape of the microprism layer(40) is stably fixed, and then cured using UV rays to ensure that the microprism shape is safely maintained. I

n addition, the microprism layer(40) is formed on one side of the printing layer(10). The microprism layer(40) may be manufactured in a state in which a protrusion is formed on one surface and then attached to the surface of the printing layer.

Next, a fifth step (S50) is performed to form an adhesive layer(50) composed of an adhesive(52) and a solid garden end on one side of the printing layer(10).

The adhesive layer(50) may include an adhesive(52) and a solid garden end, and may be laminated in the order of the adhesive(52) and the solid garden end on one side of the printing layer(10) as shown in FIG. 3.

The adhesive may be applied to any product that can be used as an adhesive, for example, TPU may be applied. The adhesive is preferably TPU of a transparent material applied.

In addition, the high garden end is composed of artificial leather and can be fixed to the fabric through sewing.

A sixth step (S60) of obtaining a semi-finished product in which the solid end, the adhesive(52), the microprism layer(40), the printing layer(10), and the coating layer(20) are stacked on one side of the fabric(60) are performed in turn.

Next, the seventh step (S70) of cutting the semi-finished product to complete the shoe upper member is performed.

The semi-finished product is cut using a cutting mold formed with a plurality of holes corresponding to the shape of the plurality of images formed on the printing layer(10) to complete the shoe upper member.

The seventh step (S70) includes preparing a cutting frame in which a plurality of holes are formed corresponding to the shape and size of a plurality of images arranged continuously repeatedly by placing a tolerance of a predetermined length prepared in the first step(S10), and settling the cutting frame to expose a plurality of images continuously repeated on the top of the semi-finished product, and pressing the cutting frame in the direction of the semi-finished product to separate the semi-finished product correspondingly with the plurality of images.

The above-described technology describes the part applied to the shoe upper, but it can be applied to both the wrapping of the vehicle and products that require an external sheath other than the shoe. As such, it will be appreciated that the above-described technical configuration of the present invention may be practiced in other specific forms without changing the technical spirit or essential features of the present invention by those skilled in the art. Therefore, the embodiments described above should be understood as exemplary in all respects and not static, and the scope of the present invention is indicated by the claims described later rather than the detailed description above, and the meaning and scope of the claims and the equivalent concept thereof Any changes or modified forms derived from the concept should be construed as being included above in the present invention.

What is claimed is:

1. A shoe upper member comprising:
a coating layer protecting the printing layer on the upper part of the printing layer;
a protective film layer located above the coating layer to protect the coating layer;
a microprism layer formed on the lower side of the printing layer and formed by a plurality of projections protruding downward; and
an adhesive layer formed below the microprism layer and formed so that it can be attached to the fabric,
wherein the microprism layer is a patterned shoe shell skin material characterized in that the printing layer is imprinted in a microprism shape and then fixed by UV curing.

2. A manufacturing method of shoe upper member, comprising;
forming a coating layer on one side of the protective film layer;
forming a printing layer on the coating layer;
imprinting the other side of the printing layer in a microprism shape;
UV-curing and fixing the other side of the printing layer on which the microprism shape is formed; and
forming an adhesive layer on the other side of the printing layer.
